(19) United States
(12) Patent Application Publication
(10) Pub. No.: US 2001/0005741 A1
(43) Pub. Date: Jun. 28, 2001

(54) ADHESIVE POLYMER AND METHOD OF USE

(76) Inventors: GREGORY BREYTA, SAN JOSE, CA (US); THOMAS CARL CLARKE, MORGAN HILL, CA (US); DANIEL JOSEPH DAWSON, SAN JOSE, CA (US); RONALD P. ESCH, SAN JOSE, CA (US); ALFRED FLOYD RENALDO, SAN JOSE, CA (US)

Correspondence Address: MERCHANT GOULD SMITH EDELL WELTER &, SCHMIDT, 3100 NORWEST CENTER, 90 SOUTH SEVENTH STREET, MINNEAPOLIS, MN, 55402

(21) Appl. No.: 09/219,591

(22) Filed: Dec. 23, 1998

(51) Int. Cl. C08F 4/04

(52) U.S. Cl. 526/218.1; 430/97; 430/423

(57) ABSTRACT

An adhesive composition includes a polyphenolic polymer which has a first repeating unit and a second repeating unit of the formula:

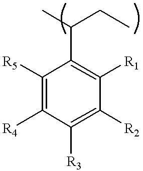

wherein each of R₁, R₂, R₃, R₄, R₅ is individually a hydroxy, H, or an azo dye and only one of R₁, R₂, R₃, R₄, and R₅ is hydroxy.

### FIELD OF THE INVENTION

The invention relates generally to a process of forming patterned structures on a substrate utilizing a bilayer metal lift-off technique. More particularly, the invention relates to adhesive polymers for coupling such a process.

### BACKGROUND OF THE INVENTION

The use of bi-layer resist lift-off processing in the fabrication of integrated circuit components and other thin film structures such as field effect transistors (FET), conductor patterns and magnetic sensing transducers, is well known in the art. For example, U.S. Pat. No. 4,814,258 granted to Tam discloses a bi-layer lift-off process utilized for the fabrication of various types of FETs, and European Patent Application No. 0 341 843 published Nov. 15, 1989 discloses a bi-layer metal lift-off process for forming conductor patterns on a substrate.

Basically, the bi-layer lift-off system comprises a release layer formed on a suitable substrate which is then covered by a top imaging layer of photoresist. A Diazonapthoquinone (DNQ)/Novolac positive resist is suitable for use as the top imaging layer. Polydimethylglutarimide (PMGI), a polymer supplied by the Shipley Company, is a suitable material which is typically used as a release layer. The top imaging layer is exposed and developed to provide the desired pattern. The release layer is then flood exposed and developed to expose the substrate surface for subsequent deposition of the desired structural features. During the development step, the release layer is undercut from the edges of the resist pattern a desired amount to facilitate the subsequent lift-off step.

A major difficulty and limitation of the bi-layer lift-off process utilizing PMGI as the release layer is the loss of, or reduced, adhesion of the PMGI layer to the underlying substrate surface at lower prebake temperatures. Good adhesion of PMGI to various substrate materials has been obtained by oven baking at temperatures in the range of 190° to 290° C., near or above the glass transition temperature for the PMGI resin.

However, bake temperatures below 150° C., have resulted in, at best, marginal adhesion characteristics. Further, the relatively high prebake temperatures required for suitable adhesion in PMGI systems can result in oxidation of the underlaying deposition surface, particularly certain metals, further resulting in reduced yields and degraded performance of the finished product.

One solution to this problem is disclosed in Krounbi, et al., U.S. Pat. No. 5,604,073 which teaches enhancing adhesion through addition of azo-type dyes to polydimethylglutarimide. However, this solution still provides results of uncontrolled adhesion failure in some instances.

As a result, there is a need for compositions and processes which provide films having enhanced adhesion which can also be used in photoresist processes.

### SUMMARY OF THE INVENTION

In accordance with a first aspect of the invention, there is provided an adhesive composition having a polyphenolic polymer with repeating monomeric units of the formula:

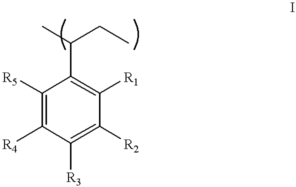

wherein R₁, R₂, R₃, R₄, and R₅ are individually hydrogen, a hydroxy group or an azo dye and wherein only one of R₁, R₂, R₃, R₄, and R₅ is a hydroxy group. Optionally, the composition of the invention may be used as a polymeric release layer.

A second aspect of the invention includes a bi-layer lift-off structure. The structure includes a release layer disposed on a substrate. The release layer includes a solution of polydimethylglutarimide and a predetermined amount of an adhesive composition. A top imaging layer of photoresist material is disposed on the release layer. The adhesive composition includes a polyphenolic polymer having repeating monomeric units of the formula:

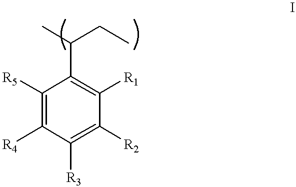

wherein R₁, R₂, R₃, R₄, and R₅ is hydrogen, hydroxy group or an azo dye and wherein only one of R₁, R₂, R₃, R₄, and R₅ is a hydroxy group.

A third aspect of the invention includes a tri-layer lift-off structure. The structure includes an adhesion promoter layer disposed on a substrate. The adhesion promoter layer includes a predetermined amount of an adhesive composition. A release layer includes a material comprising a solution of polydimethylglutarimide disposed on the adhesion promoter layer. A top imaging layer of photoresist material is disposed on the release layer. The adhesive composition includes a polyphenolic polymer having repeating monomeric units of the formula:

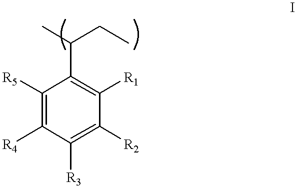

wherein R₁, R₂, R₃, R₄, and R₅ is hydrogen, a hydroxy group or an azo dye and wherein only one of R₁, R₂, R₃, R₄, and R₅ is a hydroxy group. Optionally, the composition of the invention may be used as a polymeric release layer.

The polymer of the invention may also be mixed with copolymers such as styrenics, methacrylates, vinyl esthers, alcohols, and acetates among others.

A new series of polymers have been prepared that form films exhibiting superior adhesion to substrates of current interest in tape head manufacture and in the development line for advanced DASD heads.

The materials are polyphenolics (e.g. polyhydroxystyrene) which have been reacted in such a way as to incorporate azo-dye moieties onto the polymer chain and become an integral part of the polymer. By choosing the dye structure one can tailor both the absorption characteristics and the solubility of the polymer film in both developer and solvents. Additionally, it was unexpectedly found that this class of polymers exhibit enhanced adhesion to substrates of interest in the manufacture and development of tape and DASD storage heads. They can be used in films alone or in admixture with currently used materials (such as PMGI). The materials are prepared by a simple coupling reaction between a polyphenolic compound and the desired diazonium salt(s).

Incorporation of an azo dye into polyvinylphenol (PVP) has been shown to produce outstanding adhesion onto a variety of substrates such as these comprising quartz, alumina, metals and alloys thereof, and silicon dioxide. Use of this polymeric dye with thick PMGI in a bi-layer scheme for gold sputtered coil liftoff process generated features without any presence of adhesion failure. The polymeric dye could either be formulated into the PMGI (about 0.5-10% w/w solution) or used as a separate liftoff or adhesion layer (about 3-5% in casting solvent) with no loss of adhesion of fine features at low prebake temperatures (about 130-160° C.). No material was present after normal development processes using a KOH developer. Adhesion failure was never observed with the polymeric dye whereas use of PVP or dye alone did not improve PMGI adhesion when compared to the control formulation (SFN-15 from MCC) used in the current tape head process.

### BRIEF DESCRIPTION OF THE DRAWING

The foregoing, and other objects, features and advantages of the invention will be apparent from the following more particular description of the preferred embodiment of the invention, as illustrated by the accompanying drawings, in which like reference numerals indicate like parts and in where:

FIGS. 1-4 are cross-sectional views illustrating the structures formed during the steps of a bi-layer lift-off process;

FIGS. 5-8 are cross-sectional views illustrating the structures formed during the steps of a tri-layer lift-off process.

FIG. 9 is a pictoral depiction of the results achieved in Example 11.

FIG. 10 is a pictoral depiction of the results achieved in Example 12.

FIG. 11 is a pictoral depiction of the results achieved in Example 13.

### DETAILED DESCRIPTION OF THE PREFERRED EMBODIMENT

The invention is an adhesive polymer which incorporates pendent azo dye moieties and methods of using the same in bi-layer and tri-layer lift-off processes.

### The Polymer

Incorporation of an azo dye into polyvinylphenol (PVP) has been shown to produce outstanding adhesion onto a variety of substrates such as quartz, alumina and silicon dioxide (native).

As described above, a major limitation encountered when using PMGI as the release layer material is loss of adhesion at low prebake temperatures, the low temperatures being required to minimize undesirable oxidation and corrosion of previously formed structural materials. In accordance with the principles of the present invention, the adhesion characteristics of the PMGI are greatly improved by the addition to the PMGI of small amounts of polymeric azo dyes.

Chemically, the azo class is subdivided according to the number of azo groups present into mono-, dis-, tris-, and tetrakis- among others. Azo dyes contain at least one azo group (—N═N—) but can contain two (disazo), three (trisazo), or, more rarely, four or more (polyazo) azo groups. The azo group is attached to two radicals of which at least one, but more usually, both are aromatic. They exist in the trans form where the bond angle is about 120° and the nitrogen atoms are sp² hybridized and may be represented as follows in formula I.

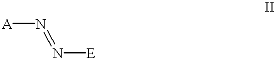

In monoazo dyes, the most important type, the A radical often contains electron-accepting groups or donating and the E radical contains electron-donating groups, particularly hydroxy and amino groups. If the dyes contain only aromatic radicals such as benzene and naphthalene, they are known as carbocyclic azo dyes. If they contain one or more heterocyclic radicals, the dyes are known as heterocyclic azo dyes.

All coupling components used to prepare azo dyes have the common feature of an active hydrogen atom bound to a carbon atom. Compounds of the following types can be used as azo coupling components: (1) aromatic hydroxy compounds such as phenols and naphthols; (2) aromatic amines; (3) compounds that possess enolizable ketone groups of aliphatic character, i.e., compounds that have active methylene groups, where X is an electron attracting group such as —COR, —COOH, —CN, R is alkyl or aryl, and Y is usually a substituted or unsubstituted amino group;

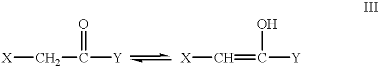

and (4) heterocyclic compounds such as those containing pyrrole [109-97-7], indole [120-72-9], pyridine [110-86-1], pyrimidine [289-95-2], and similar ring systems, such as 5-pyrazolones.

Analogous to aromatic halogenation, nitration, and sulfonation, the azo coupling reaction is an electrophilic aromatic substitution. The effect of the reaction rate of substituents on both the diazo and the coupler components is in agreement with this mechanism. Thus the reaction is facilitated by electron-attracting groups in the diazo components, and by electron-donating groups in phenol and aromatic amine-type coupler components. The reactivity of coupling components (nucleophilic substrate) increases with increasing basicity. The phenoxide ion (ArO⁻) and free amine (ArNH₂) are more basic than corresponding free phenol and the ammonium ion (C₆H₅NH₃⁺) and, therefore, react more easily.

Generally this adhesive composition includes a polyphenolic polymer with repeating monomeric units of the formula:

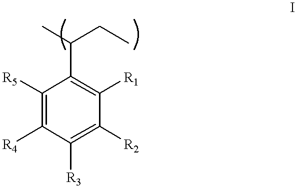

wherein R₁, R₂, R₃, R₄, and R₅ is hydrogen, a hydroxy group or an azo dye, and wherein only one of R₁, R₂, R₃, R₄, and R₅ is a hydroxy group. R₁ through R₅ may be any different type of azo dyes including a mono azo dye, a diazo dye or a triazole including various aromatic structures phenyl, naphthyl, anthracenyl, among others. Further substituents to these aromatic structures include NO₂, SO₂Y, COOR, OR, CN, NR₂, or a halogen wherein R is an alkyl and these substituents may be located at the ortho, meta, or para position. Useful azo dyes include commercially available Fast-Dyes such as:

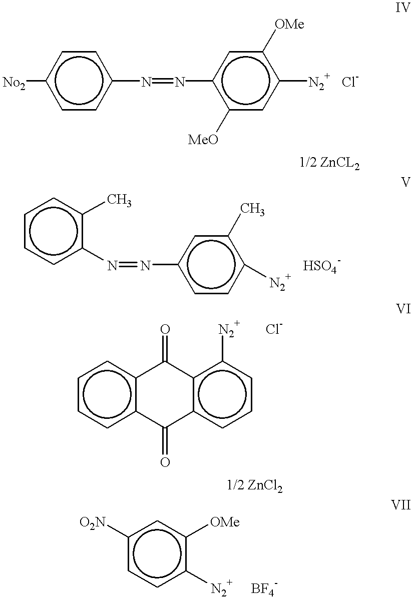

In use, R—R₅ may be an azo dye moiety or a tirazole moiety comprising alkyl groups, alkyl aryl groups, or substituted or unsubstitutes aryl groups such as benzene. These dyes may be joined through azo functionality at the site of the ionic bond by stripping the anion from the dye.

Two common species of azo substituents may be found in formulas VIII and IX below:

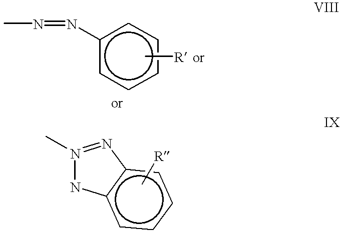

where R′ and R″ is aryl alkyl, aryl or an alkyl. Typically R′ and R″ include H; —OH; a C1-12 branched or linear alkyl; an OR′″ groups where R′″ may be C₁-C₅ alkyl groups such as —OCH₃, OCH₂CH₃, —OCH₂CH₂CH₃; —COOH; —COCH₃; —COCH₂CH₃; —COCH₂CH₂CH₃; SO₃H; and SO₂NH₂ and among others.

The resulting polymer generally has a molecular weight (weight average) ranging from about 2000 to 80,000, and preferably from about 5000 to 15,000. The solubility of the polymer may be varied by increasing molecular weight or by including pendent moieties with varying pH sensitivities. for example, as the molecular weight of the polymer increases solubility generally decreases. Further, use of dye moieties with acidic pendent groups generally increases solubility in alkaline solutions. In turn, use of dye moieties with alkyl or alkoxy pendent groups decreases solubility generally.

The polymer may also be mixed with any number of copolymers of varying types and molecular weights. Examples of useful copolymers include styrenics, acrylates and methacrylates, vinylethers, alcohols, and acetates among other copolymers.

Preferably the adhesive composition is a terpolymer composition of two different azo dye components and a phenol component. The preferred terpolymer composition of the azo dyes is illustrated below.

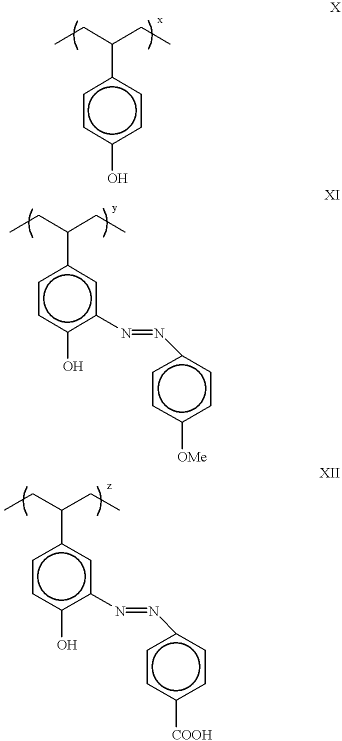

wherein x is 50, y is 25 and z is 25 mole-%, and x+y+z=100 mole-%.

In one embodiment of the invention, the terpolymer composition illustrated above, is incorporated into the PMGI release layer at concentrations in the range of 0.5 to 10 percent (by weight). The typical release layer thickness can be from 500 angstroms to 3 μm thick. This layer is typically softbaked at 130-200° C. for 10-30 minutes.

### Processing

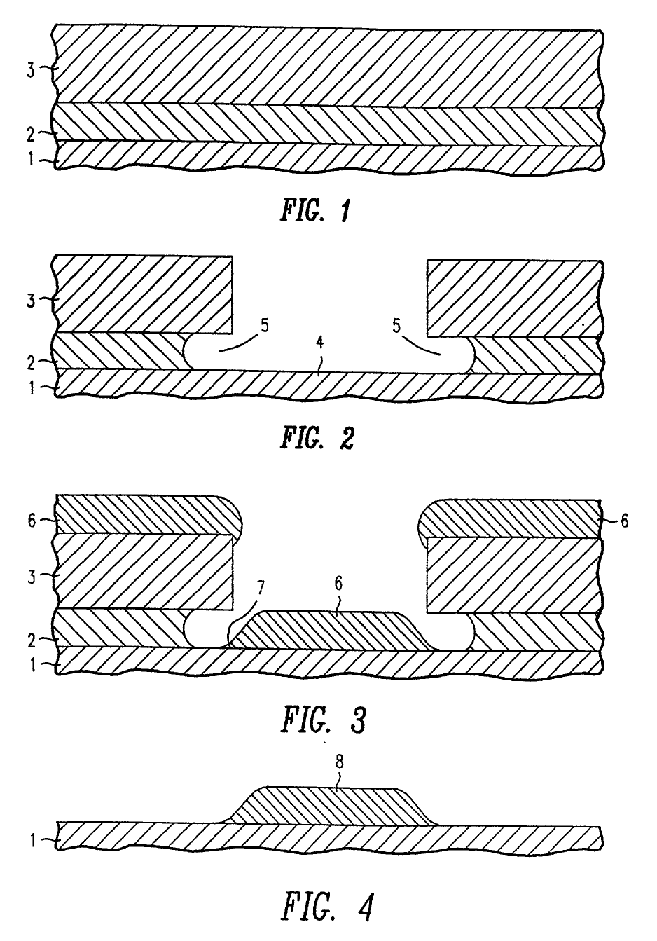

Referring now to FIGS. 1-8, bi-layer lift-off processes are utilized when it is desired to produce well-defined patterns on a substrate surface by deposition techniques, such as evaporation or sputtering.

FIG. 1 shows a substrate 1 coated with a bi-layer which includes an organic release layer 2 which may comprise polydimethylglutarimide (PMGI)and the polymeric adhesive composition of the invention and a top imaging layer 3 of a suitable photoresist (referred to as “resist”). The resist layer 3 and the release layer 2 are then developed, resulting in the structure as shown in FIG. 2 with the substrate surface 4 exposed and the release layer 2 undercut 5 below the resist layer 3. A desired material, such as a conductive metal, is next deposited, such as by sputter deposition, for example, leading to the formation of a layer 6 covering the exposed substrate surface 4 and the top resist layer 3 as shown in FIG. 3. The amount of deposited material 7 extending into the undercut area 5 is primarily determined by the thickness of the release layer 2.

Finally, lift-off of the unwanted material 6 deposited over the top resist layer 3 is carried out using, for example, an organic solvent or aqueous alkali to dissolve the release layer and top resist layers releasing the deposited material 6. The end result is shown in FIG. 4 wherein the substrate 1 has been selectively coated with a patterned metal conductor 8, for example.

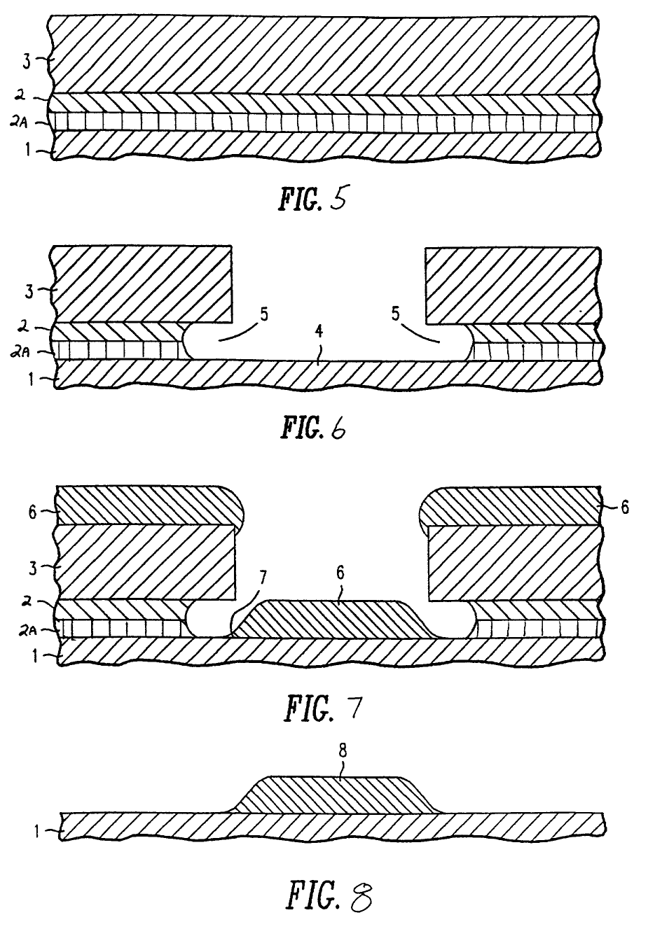

An alternative embodiment incorporates a separate layer of the polymeric adhesive composition of the invention between the release layer 2 and the substrate 4. FIG. 5 shows a substrate 1 coated with a tri-layer film which includes an adhesion promoter layer 2A, a release layer 2 of PMGI, and a top imaging layer 3 of a suitable photoresist (referred to as “resist”). The resist layer 3, release layer 2 and adhesion promoter layer 2A are developed, resulting in the structure as shown in FIG. 6 with the substrate surface 4 exposed and the release layer 2 and the adhesion promoter layer 2A undercut 5 below the resist layer 3. A desired material, such as a conductive metal, is next deposited, such as by sputter deposition, for example, leading to the formation of a layer 6 covering the exposed substrate surface 4 and the top resist layer 3 as shown in FIG. 7. The amount of deposited material 7 extending into the undercut area 5 is primarily determined by the thickness of the release layer 2 and adhesion promoter layer 2A. Finally, lift-off of the unwanted material 6 deposited over the top resist layer 3 is carried out using, for example, an organic solvent or aqueous alkali to dissolve the release layer 2, the adhesion promoter layer 2A and top resist layer 3 releasing the deposited material 6. The end result is shown in FIG. 8 wherein the substrate 1 has been selectively coated with a patterned metal conductor 8, for example.

The terpolymer composition can be used as a separate adhesion promoter layer forming a tri-layer system. The adhesion promoter layer is between the substrate and the release layer. Typically the adhesion promoter layer is about 200-1000 Angstroms thick. This layer is typically softbaked at 130-190° C. for 10-30 minutes.

The polymer may also be formed as an autonomous release layer without use of the PMGI binder.

The top layer is a photoresist. Typically the thickness of the photoresist can be from 0.5 to 5 μm. This layer is typically softbaked at 90-130° C. for 10-30 minutes.

For use in the present invention, the PMGI should preferably have a weight average molecular weight (polystyrene as a standard) within the range of 10,000 to 40,000. The choice of the molecular weight depends on the depth of undercut desired for specific applications, which is also a function of developer strength as well as temperature and development time. An absolute weight average molecular weight of approximately 20,000 is most preferred in the examples given above. Additionally, the glass transition temperature (T_{g}) of the PMGI resin should have a value within the range of 140° to 250° degrees C. A T_{g} of approximately 185° degrees C., is most preferred in the examples given below.

The terpolymer composition adheres to a variety of substrates such as metals, metal alloys, quartz, alumina and silicon dioxide. Additionally, formulations of the azo dyes in PMGI have exhibited a shelf-life of at least twelve months with minimum deterioration of desirable characteristics.

Generally, the organic underlayer may be applied by spin coating and then optionally heat baked at temperatures ranging from about 90° C. to 250° C. for a period of time sufficient to evaporate any solvent present and, if necessary, cure the polymer. The photoresist may then be deposited by spin-coating and developed using actinic radiation at 193 nm, 248 nm, 365 mn, or 435 nm. The image may then be developed using any developer known to those of skill in the art.

In a preferred embodiment, the bi-layer resist system of the present invention can be adapted to deposit the electrical lead conductors in a magnetoresistive (MR) sensor. Since in an MR sensor the lead conductors also define the read track width, definition of the lead conductor structure is critical. Definition of the track width is determined by the degree or amount of undercut 5 (as shown in FIGS. 2 and 5). The amount of undercut 5 also determines the effectiveness of the lift-off. For a given set of thicknesses and PMGI composition, the amount of undercut generated is primarily a linear function of the development time and the prebake temperature for the PMGI release layer, the developer concentration and temperature being held constant.

The concentration of solvent, polymer, PMGI, and copolymer will vary depending on the application of the system. For example, if the polymer of the system is intended for use as an adhesion promoting layer film thickness is less critical, however, polymer concentration is of greater importance. If the polymer is to be used as a lift off layer, film thickness is more critical and can be varied by the concentration fo copolymer, PMGI, and solvent. Generally, the use concentrations can be vaired within the guideline concentrations provided below.

| | concentration (wt-%) |
|---|---|
| solvent | 80 wt-% to 99 wt-% |
| polymer | 1 wt-% to 20 wt-% |
| PMGI* | 3 wt-% to 19 wt-% |
| Copolymer* | 0.5 wt-% to 5 wt-% |

*When present

### WORKING EXAMPLES

The following example is a nonlimiting illustration of the invention.

### Example 1

Con HCI (4.11 g) was diluted to 20.5 g with water. To this was added aniline (1.9) mL) using ice bath cooling. To this was added a saturated solution of sodium nitrite (1.44 g) in water.

Separately poly(4-hydroxystyrene) (5 g) and 50% NaOH (3.3 g) were dissolved into methanol (25 mL) using ice cooling. To this was added the first solution dropwise. After stirring for 1 hour con Hcl was added dropwise until pH+3. Approx. 100 mL water added to the reaction then filtered and sucked dry to give a brownish solid. This solid was taken up into a mixture of acetone/cyclohexanone (approx. 50 mL) and re-precipitated into water (750 mL), filtered, sucked dry then dried under high vacuum at 60 deg. C.

A 10% by weight solution of this polymer in cyclopentanone was spin coated onto a quartz wafer and baked at 150 deg C. for 2 min. The film had an optical density of 3/μm at 365 nm.

### Example 2

The procedure of Example 1 was used replacing the aniline with p-anisidine (2.6 g).

A 10% by weight cyclopentanone solution of the polymer so produced was spin cast onto a quartz wafer and baked on a hot plate at 152 deg. C. for 2 min. The film had an optical density of 4.7/μm at 365 nm.

### Example 3

The procedure of Example 1 was used replacing the aniline with p-aminobenzoic acid (2.86 g).

A 10% by weight cyclopentanone/NMP solution of the polymer produced was spin cast onto a quartz wafer and baked on a hot plate at 150 deg. C. for 2 min. The film had an optical density of 3.4/μm at 365 nm.

### Example 4

Conc. HCI (68 mL) was added to a stirring ice-cooled mixture of p-anisidine (26 g) and p-aminobenzoic acid (28 g) in H₂O (250 mL). Next a solution of NaNO₂ (28.8 g) in H₂O (50 mL) was added maintaining temperature below 5° C.

Separately, 50% NaOH (76 g) was added to an stirring ice-cooled solution of poly(4-hydroxystyrene) 100 g) in 500 mL MeOH. Next, the diazonium solution prepared above was added slowly maintaining temperature below 5° C. After addition the reaction temperature was maintained at 0-5° for 1 hour, then allowed to come to room temperature and stir overnight.

The next day the reaction was cooled with ice and conc. HCl (168 mL) was added and stirred for 1 hour. The precipitate was filtered and rinsed with water. The solid was twice re-slurried in water (500 mL) and filtered, then rinsed with additional water and sucked dry. This polymer was then dried at 65° C. in a vacuum oven overnight affording approximately 150 g of a dark solid.

### Example 5

The procedure of Example 1 was used replacing the aniline with o-nitroaniline (2.88 g).

### Example 6

Copolymer from Example 3 (3.9 g) and 8N NaOH (50 mL) was dissolved in 50 mL EtOH and heated to 85-90° C. under nitrogen. To this was quickly added formamidinesulfinic acid (2.4 g). After 1 hour the reaction was cooled with an ice bath and acidified to pH+3 with con. HCl, filtered, rinsed with water, sucked dry then dried in a 65° C. vacuum oven overnight.

### Example 7

50 g of the polymer prepared in Example 4 was dissolved into 282 g of cyclopentanone to give a 15% by weight solution.

### Example 8

60 g of the solution prepared in Example 7 was dissolved into 1200 g of a 15% by weight solution of PMGI in cyclopentanone/NMP (Nano SFN15, MicroChem Corp). This solution was filtered through a 0.2 μm capsule filter prior to use.

### Example 9

Alternatively, 1.9 g of the polymer prepared in Example 4 was dissolved directly into 262 g of a 15% by weight solution of PMGI in cyclopentanone/NMP (Nano SFN15, MicroChem Corp.). This solution was filtered through a 0.2 μm capsule filter prior to use.

### Example 10

1 g of Adhesion Promoter Polymer from Example 4 was dissolved into 19 g of cyclopentanone and filtered through a 0.2 μm filter prior to use.

### Example 11

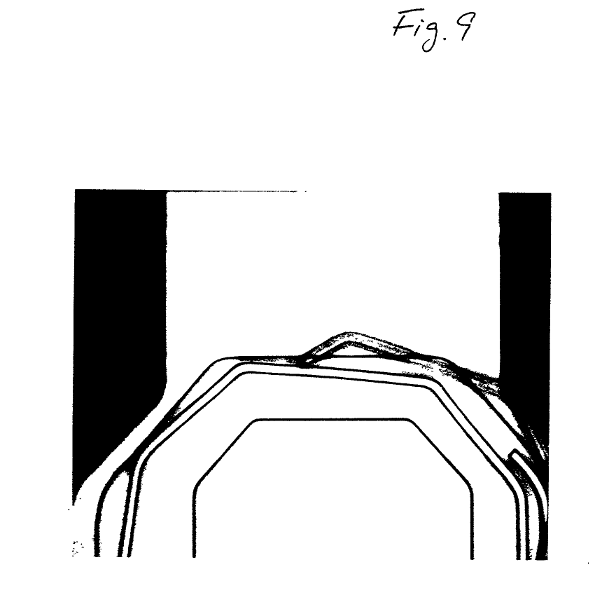

A solution of PMGI (Nano SFN15, Microelectronic Chemicals Corp.) was spin cast (2500 rpm, 30 sec.) onto an alumina substrate and baked at 150° C. for 30 min. on a hot plate. Over this was applied photoresist (SJR 5440, Shipley Company) (3000 rpm, 30 sec.) and baked for 15 min. at 110° C. on a hot plate. The resist was then exposed through a mask and developed in 6/1 Microposit 2401 (Shipley Co.)/water at 20° C. for 460 sec. The wafer was next flood exposed under Deep UV light for 10 sec. and re-developed in 6/1 Microposit 2401/water at 20° C. for 15 sec. Results in FIG. 9 shows massive adhesion loss from substrate.

### Example 12

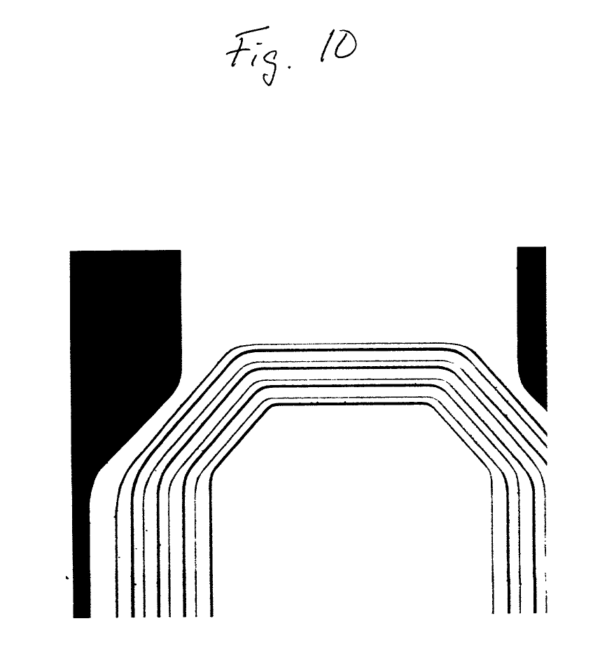

A solution of PMGT containing Adhesion Promoter prepared as in Example 10 was used in place of the PMGI described in Example 13. Result in FIG. 10 shows no adhesion loss from substrate.

### Example 13

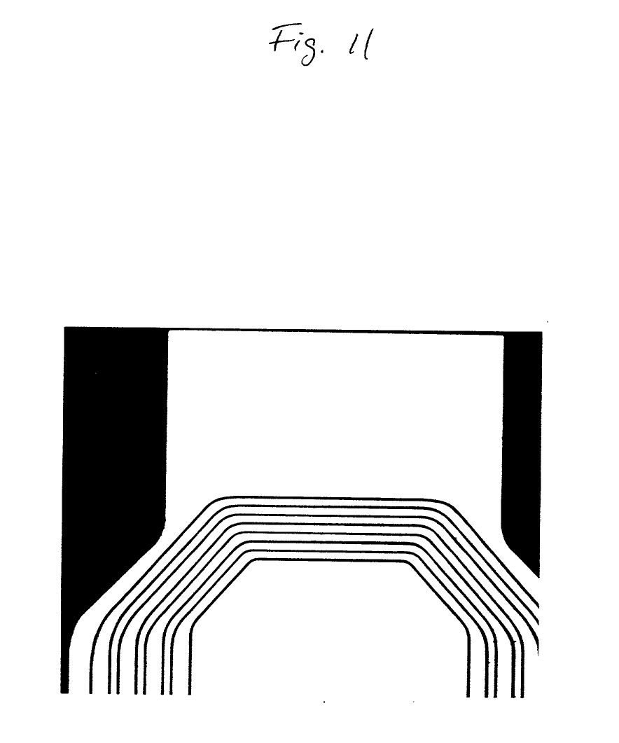

A thin film of Adhesion Promoter was spin coated from the solution prepared in Example 12 (2500 rpm, 30 sec) onto an alumina substrate and baked on a hot plate for 5 min. at 150°. The wafer was then processed as described n Example 13. Result in FIG. 11 shows no adhesion loss from substrate.

Iμ, the most preferred embodiment, the preparation of these polymers is by reaction of a diazonium salt directly with the phenolic polymer. The desired polymeric structure can also be achieved by polymerization of monomeric units containing the desired adhesion-promoting unit(s) and any other co-monomers.

In some applications it may also be necessary to minimize or eliminate the use of material that may leave metal or halide ions in the product polymer after manufacture. Therefore exchange non-ionic or organic materials for these materials, for example a tetraaklylammonium hydroxide for the sodium hydroxide an/or another non-halide acid such as trifluoracetic acid or trichloracetic acid or a sulfuric or sulfonic acid.

The reaction of the fast dyes and other commercially available diazonium salts to phenolic polymer backbones is analogous to other reactions where we form the diazonium salt in situ. These material are reacted directly with the polymeric phenoxide followed by neutralization or acidification.

While the present invention has been particularly shown and described with reference to a preferred embodiment thereof, it will be understood by those skilled in the art that various changes in form and detail may be made therein without departing from the spirit, scope and teaching of the invention. Accordingly, the invention herein disclosed is to be considered merely as illustrative and limited in scope only as specified in the appended claims

We claim:

1. An adhesive composition comprising a polyphenolic polymer said polymer comprising repeating monomeric units having the formula: 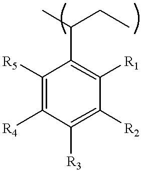
wherein each of R₁, R₂, R₃, R₄, and R₅ are each individually a hydroxy group, hydrogen or an azo dye, and only one of R₁, R₂, R₃, R₄, and R₅ is hydroxy.

2. The composition of claim 1, wherein said first and polymer comprises second repeating units which are different.

3. The composition of claim 1, wherein said polymer comprises first and second repeating units which are monoazo dyes.

4. The composition of claim 3, wherein said monoazo dye has the formula: 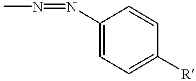
wherein R′ is an alkyl moiety, an alkoxy moiety, or a carboxylate moiety..

5. The composition of claim 3, wherein said monoazo dye has the formula: 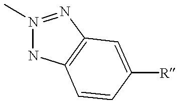
wherein R″ is an alkyl moiety, an alkoxy moiety, or a carboxylate moiety.

6. The composition of claim 4, wherein R′ comprises H, —OH, OR¹″ wherein R^{1″}is a C₁-C₅ alkyl, —COOH, —COCH₃, —COCH₂CH₃, —COCH₂CH₂CH₃, SO₃H, and a C₁-C₁₂ branched or linear alkyl.

7. The composition of claim 5, wherein R″ comprises H, —OH, —OCH₃, —OCH₂CH₂CH₃, —COOH, —COCH₃, —COCH₂CH₃, —COCH₂CH₂CH₃ and SO₃H.

8. The composition of claim 1, wherein said polymer comprises a terpolymer composition having repeating units of the formula: 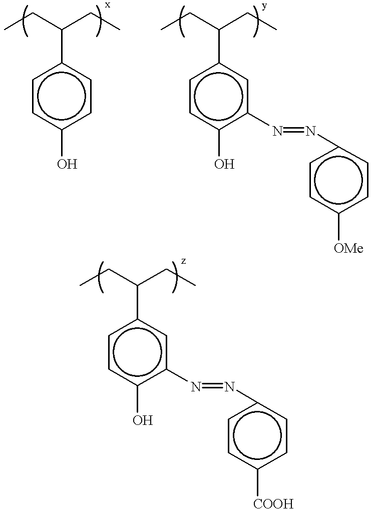
wherein x, y and z added together equal 1.

9. The composition of claim 8, wherein x comprises from about 0 mol-% to 50 mol-%, y comprises from about 0 mol-% to 50 mol-%, and z comprises from about 0 mol-% to 50 mol-%.

10. The composition of claim 1, wherein the polymer has a molecular weight ranging from about 3000 to 80,000 MW_{(w)}.

11. The composition of claim 9, wherein x comprises about 50 mole-%, y comprises about 25 mole-%, and z comprises about 25 mole-%.

12. The composition of claim 1 additionally comprises polydimethylglutarimide.

13. The composition of claim 12, wherein said polydimethylglutarimide is present in the composition in a range of from about 0 to 99% w/w.

14. The composition of claim 13, wherein said composition comprises a liquid.

15. The composition of claim 1, additionally comprising a copolymer.

16. A bi-layer lift-off structure comprising:
a release layer disposed on a substrate, said release layer of a material comprising a solution of polydimethylglutarimide and a predetermined amount of an adhesive composition and a top imaging layer of photoresist material disposed on said release layer, wherein said adhesive composition comprises a polyphenolic polymer said polymer comprising a repeating monomeric units having the formula: 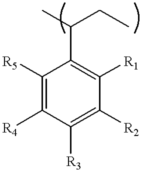
wherein each of R₁, R₂, R₃, R₄, R₅ are individually a hydroxy group, hydrogen or an azo dye moiety, and only one of R₁, R₂, R₃, R₄, and R₅ is a hydroxy group..

17. The structure of claim 16, wherein said predetermined amount being an amount required to form a solution wherein said adhesive composition comprises 0.5 to 50 percent by weight of said polydimethylglutarimide.

18. The structure of claim 16, wherein said adhesive composition comprises a terpolymer composition having repeating units of the formula: 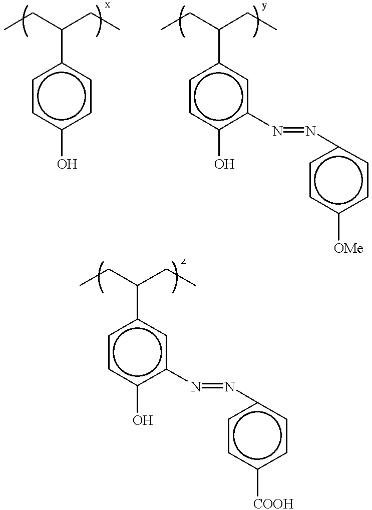
wherein x, y and z added together equal 1.

19. The structure of claim 18, wherein x comprises from about 0 mol-% to 50 mol-%, y comprises from about 0 mol-% to 50 mol-%, and z comprises from about 0 mol-% to 50 mol-%.

20. The structure of claim 19, wherein x comprises about 50 mole-%, y comprises about 25 mole-%, and z comprises about 25 mole-%.

21. The structure of claim 16 wherein said polydimethylglutarimide has a weight average molecular weight within the range of approximately 10,000 to 40,000.

22. The structure of claim 21 wherein said polydimethylglutatimide has a weight average molecular weight of approximately 20,000.

23. The structure of claim 16 wherein said polydimethylglutarimide has a glass transition temperature within the range of approximately 140° to 250° degrees C.

24. The structure of claim 16 wherein said polydimethylglutarimide has a glass transition temperature of approximately 185° degrees C.

25. A tri-layer lift-off structure comprising:
an adhesion promoter layer disposed on a substrate, said adhesion promoter layer comprising a predetermined amount of an adhesive composition, a release layer comprising a solution of polydimethylglutarimide disposed on said adhesion promoter layer, and a top imaging layer of photoresist material disposed on said release layer, wherein said adhesive composition comprises a polyphenolic polymer said polymer comprising repeating monomeric units having the formula: 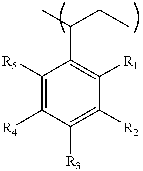
wherein each of R₁, R₂, R₃, R₄, and R₅ is individually a hydroxy group, hydrogen, or an azo dye, and only one of R₁, R₂, R₃, R₄, and R₅ is a hydroxy group.

26. The structure of claim 25 wherein said predetermined amount being an amount required to form a solution wherein said adhesive composition comprises 0.5 to 99 percent by weight of said polydimethylglutarimide.

27. The structure of claim 25 wherein said adhesive composition comprises a terpolymer composition having repeating units of the formula: 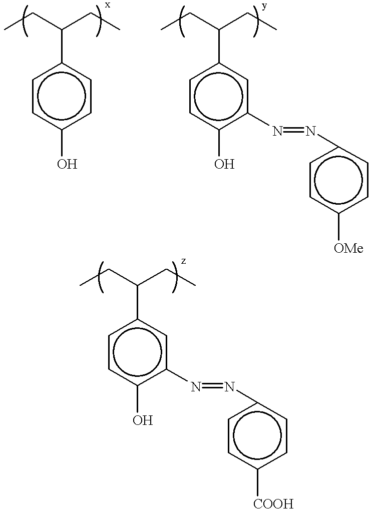
wherein x, y and z added together equal 1.

28. The composition of claim 27, wherein x comprises from about 0 mol-% to 50 mol-%, y comprises from about 0 mol-% to 50 mol-%, and z comprises from about 0 mol-% to 50 mol-%.

29. The structure of claim 26 wherein said polydimethylglutarimide has a weight average molecular weight within the range of approximately 10,000 to 40,000.

30. The structure of claim 31 wherein said polydimethylglutatinide has a weight average molecular weight of approximately 20,000.

31. The structure of claim 26 wherein said polydimethylglutarimide has a glass transition temperature within the range of approximately 140° to 250° degrees C.

32. The structure of claim 31 wherein said polydimethylglutarimide has a glass transition temperature of approximately 185° degrees C.

33. A method for generating a resist image on a substrate, comprising the steps of:
(a) coating a substrate with an organic underlayer wherein the underlayer comprises an adhesive composition comprising a polyphenolic polymer said polymer comprising repeating monomeric units having the formula: 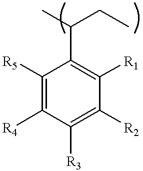
wherein each of R₁, R₂, R₃, R₄, and R₅ are each individually a hydroxy group, hydrogen, or an azo dye moiety, and only one of R₁, R₂, R₃, R₄, and R₅ is hydroxy;
(b) coating the organic underalyer with a top layer comprising a photoresist;
(c) imagewise exposing the top layer to radiation;
(d) developing the image in the top layer; and
(e) transferring the image through the organic underlayer to the substrate.

34. The method of claim 33, wherein said organic underlayer is spin coated on said substrate.

35. The method of claim 33, wherein said organic underlayer is heated to a range of about 90° C. to 250° C. after deposition

36. The method of claim 33, wherein said photoresist is applied onto said organic underlayer by spin-coating.

37. The method of claim 33, wherein said photoresist is developed with actinic radiation after depositon.

38. The method of claim 33, wherein said image is developed using an alkaline developer.
